(19) United States
(12) Patent Application Publication
(10) Pub. No.: US 2026/0259537 A1
(43) Pub. Date: Sep. 3, 2026

(54) SYSTEMS AND METHODS FOR HIERARCHICAL MODULAR AUTOMATION SYSTEMS

(71) Applicant: Siemens Aktiengesellschaft, Munich (DE)

(72) Inventors: Lukas Weidich, Munich (DE); Holger Strobel, Munich (DE); Andras Varro, Princeton, NJ (US); Florian Ersch, Princeton, NJ (US); Paul Philip, Princeton, NJ (US); Michael Jaentsch, Princeton, NJ (US); Phani Ram Kumar Kuruganty, Princeton, NJ (US); Kaan Bardak, Princeton, NJ (US); Klaus Jandl, Marktstr. 3 (AT); Gustavo Arturo Quiros Araya, Princeton, NJ (US)

(73) Assignee: Siemens Aktiengesellschaft, Munich (DE)

(21) Appl. No.: 19/163,872

(22) PCT Filed: Mar. 21, 2023
(86) PCT No.: PCT/US2023/015721

§ 371 Date: Sep. 10, 2025

(51) Int. Cl. G05B 15/02

(52) U.S. Cl. CPC G05B 15/02

(57) ABSTRACT

Methods for implementing an automation system (152) and corresponding systems (100) and computer-readable mediums (126). A method includes starting (602) a system orchestrator (168) and reading (604) a system configuration definition (156) and system manifest (158). The method includes reading (606) app configuration definitions (156) and app manifests (158) for one or more apps (154) based on the system configuration definition (156). The method includes defining (610) app configuration definitions (156) for one or more apps (154) based on the system configuration definition (156) and executing (614) the one or more apps (154) based on the app configuration definitions (156) and the app manifests (158). The method includes controlling (618) at least one external physical device (570) based on the one or more executing apps (154).

### TECHNICAL FIELD

The present disclosure is directed, in general, to software automation systems, and with particular use in software-automation systems for monitoring and control of physical manufacturing plants.

### BACKGROUND OF THE DISCLOSURE

Traditional automation systems, including manufacturing systems, are implemented by a hierarchical control architecture of automation devices implemented in special-purpose hardware controllers. For example, in a typical case, programmable logic controllers (PLCs) are used to build monolithic control systems to perform production tasks by communicating with sensors and actuators, and a higher level of PLCs may be used to control the manufacturing-layer PLCs. Because each PLC is specifically programmed to perform its discrete tasks, modifying or improving the system as a whole is prohibitively complex and expensive because many or all of the affected PLCs must be replaced, reprogrammed, or reconfigured. Even in systems using general-purpose processors under software control, the interrelation of the processors in a hierarchical system makes it difficult to alter or upgrade the system because the software control systems themselves are not easily adaptable to a changed software or hardware configuration.

Further, the configuration for industrial systems is created in environments which are usually proprietary applications with closed and unpublished storage formats for the configuration. The industrial systems themselves are implemented in a closed, encapsulated manner. Typically the PLC itself is connected to the rest of the automation system and the physical world, which prevents efficient modification, improvement, or reconfiguration of the automation system. Because the automation system is configured in a closed and rigid manner, reuse of components and functions is complicated and often impossible. Improved systems are desirable.

### SUMMARY OF THE DISCLOSURE

Various disclosed embodiments include methods for implementing an automation system and corresponding systems and computer-readable mediums. A method includes starting a system orchestrator and reading a system configuration definition and system manifest. The method includes reading app configuration definitions and app manifests for one or more apps based on the system configuration definition. The method includes defining app configuration definitions for one or more apps based on the system configuration definition and executing the one or more apps based on the app configuration definitions and the app manifests. The method includes controlling at least one external physical device based on the one or more executing apps.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates an example of an automation system in accordance with disclosed embodiments;

FIG. 3 illustrates an example of a multiple-system automation system in accordance with disclosed embodiments;

FIG. 4 illustrates an example of a hierarchal automation system 400 in accordance with disclosed embodiments;

FIG. 5 illustrates an example of a process in accordance with disclosed embodiments; and

FIG. 6 illustrates an example of a process in accordance with disclosed embodiments.

### DETAILED DESCRIPTION

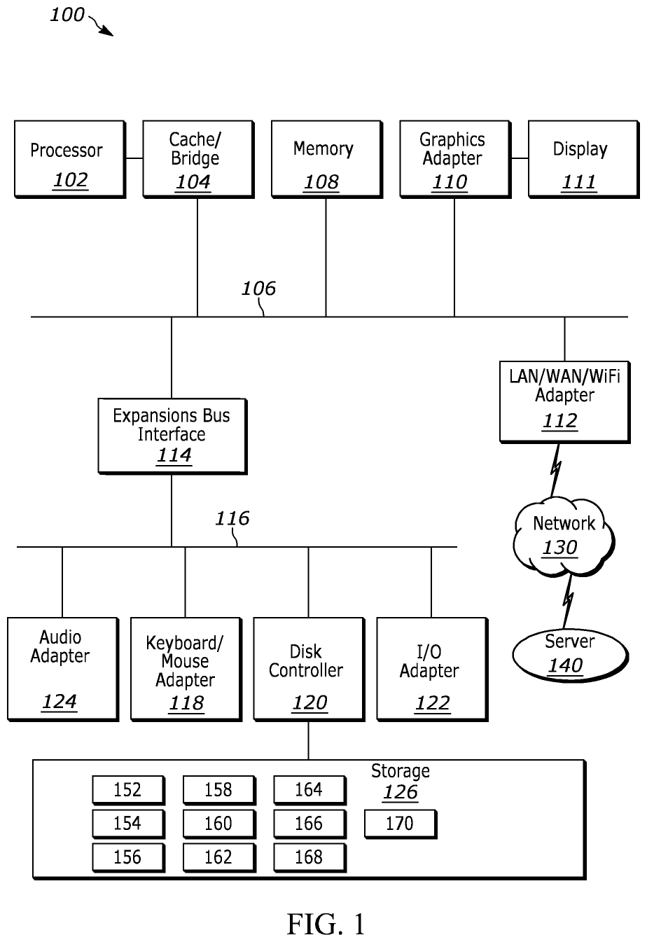

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

To increase flexibility in production and other systems, disclosed embodiments provide that the physical equipment (e.g., machines or robots) are adapted to become more modular and flexible, to operated less as isolated assets than as a meshed system. A central management of automation systems/infrastructure like compute nodes, networks, applications, etc. provide a uniform operating environment.

To support flexibility in both hardware configurations and operational control, disclosed embodiments provide for a hierarchical software system including modular software applications that are linked and orchestrated by a system orchestrator functions. These systems are also modular, and can be linked to other systems and applications to form a higher-level, more complex software control system with the distinct technical advantage of automated configuration and assembly of the application modules.

Such a reconstruction of complex process and automation infrastructures into modular automation units and subsets of easily configurable building blocks drastically decreases the cost and time to market for generating new value for manufacturing plants. Disclosed embodiments enable the next generation of manufacturing strategies to support global competitiveness, innovation, and introduction of new products, with faster market responsiveness.

Disclosed embodiments include a modular automation system that can use an overarching orchestration process to ensure the system is behaving as expected at any time and every component is in the correct state. Various embodiments include multiple modular applications, organized in hierarchies, and controlled by the system orchestrator to execute corresponding processes in given sequences in order to create complex systems of higher orders.

FIG. 1 illustrates a block diagram of a data processing system in which an embodiment can be implemented, for example as a computer system particularly configured by software or otherwise to perform the processes as described herein, and in particular as each one of a plurality of interconnected and communicating systems as described herein to implement an automation system. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. I/O adapter 122 can be connected to control, read from, write to, or otherwise communicate or interact with any number of external devices, including controllable devices, sensors, motors, actuators, and other physical devices as described herein.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system which can employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response. In other embodiments disclosed herein, the disclosed apps can run within a data processing system without a display or other human-machine interface. Such systems can read their configurations pushed to them over a data distribution system (for example RTI DDS, or similar), take inputs from the same data distribution system or from physical devices, and provide their outputs to the same data distribution system or to the physical world without any user interface. An application with user interface, including applications which are only created to provide human usable interface with the machine or system (HMI), might also connect to the data distribution system and read and publish data.

One of various commercial operating systems, such as a version of Microsoft Windows™, a product of Microsoft Corporation located in Redmond, Wash. may be employed if suitably modified. Various embodiments can be implemented using the Debian oldest operating systems based on the Linux kernel. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Storage 126 can contain any of the data, programs, or other software elements described herein, such as automation systems 152, apps 154, configuration definitions 156, manifests 158, gateway configurations 160, executable code 162, gateways 164, data for apps, systems, system orchestrators, or gateways 166, system orchestrators 168, connectors 170, and others.

An “automation system,” as used herein, refers to a software product executable by one or more data processing systems (individually or collectively) and that controls physical devices such as sensors, actuators, motors, and more complex mechanical assemblies, and other software layers such as a data acquisition layer, communication layers, and others. An automation system is a modular software control unit that comprises a system manifest, a system configuration definition, a system orchestrator, and one or more user-specified services (“apps”) to implement an automation task using the physical devices. Each app has an associated manifest and configuration definition (also referred to simply as a “configuration” for the corresponding system, subsystem, or app). The automation system may itself communicate with or be controlled by higher-level automation systems, or by other systems such supervisory control and data acquisition systems, enterprise systems, human-machine interface systems, data distribution systems, or others.

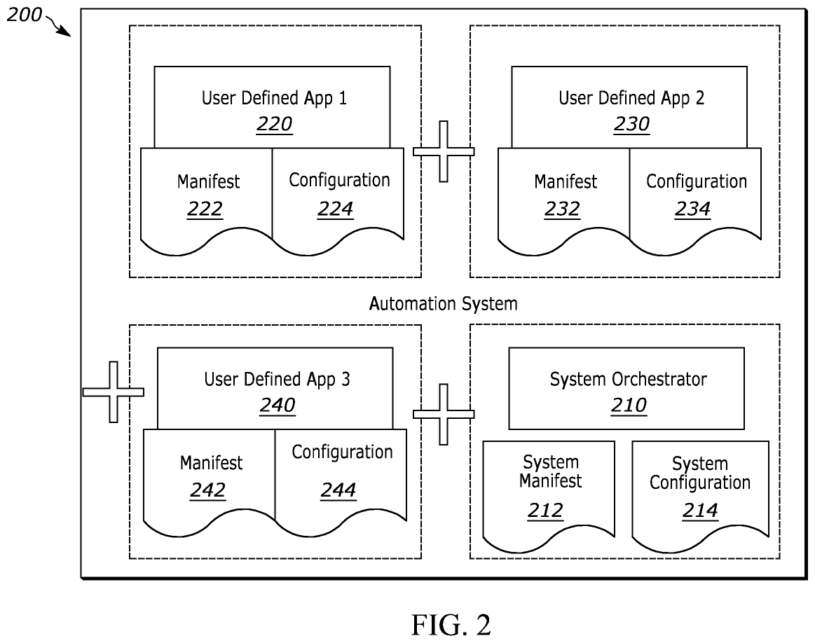

FIG. 2 illustrates a non-limiting example of an automation system 200 in accordance with disclosed embodiments. In the example of FIG. 2, automation system 200 includes system orchestrator 210 and associated system manifest 212 and system configuration definition 214. Automation system 200 also includes, in this example, three apps 220, 230, and 240. Each app has an associated manifest and configuration definition—app 220 is associated with manifest 222 and configuration definition 224, app 230 is associated with manifest 232 and configuration definition 234, and app 240 is associated with manifest 242 and configuration definition 244. Note that, in other implementations, there can be any number of apps. An app or a subsystem in an automation system may be referred to herein as an automation object.

Conventionally, software applications may be divided into independent subroutines that perform exactly one task. Each of these subroutines, whether integrated into the application or called as an external routine, are designed for that specific requirement and well tested to perform it well. However, programmers must be familiar with each of the specific requirements and functions of the subroutines, and these conventional structures are not easily treated as modular components of a large software system.

According to disclosed embodiments, by contrast, each app 220 includes additional associated files—the manifest 222 and configuration definition 224—that together define the functions and interfaces of the app 220 so that the app 220 can be treated as a modular component of the overall automation system 200. The system orchestrator 210 can use, instantiate, and configure the apps 220/230/240 on the fly during system startup or execution, as may be defined by the user, programmer, or otherwise.

Disclosed embodiments include a file-based description of the automation system 200 in the as well as a system orchestrator 210 that fulfills overarching tasks within the automation system 200. Note that while the example of FIG. 2 is a single automation system with multiple apps, each automation system can be a modular component subsystem of another, higher-level automation system and be controlled by a system orchestrator of that higher-level system.

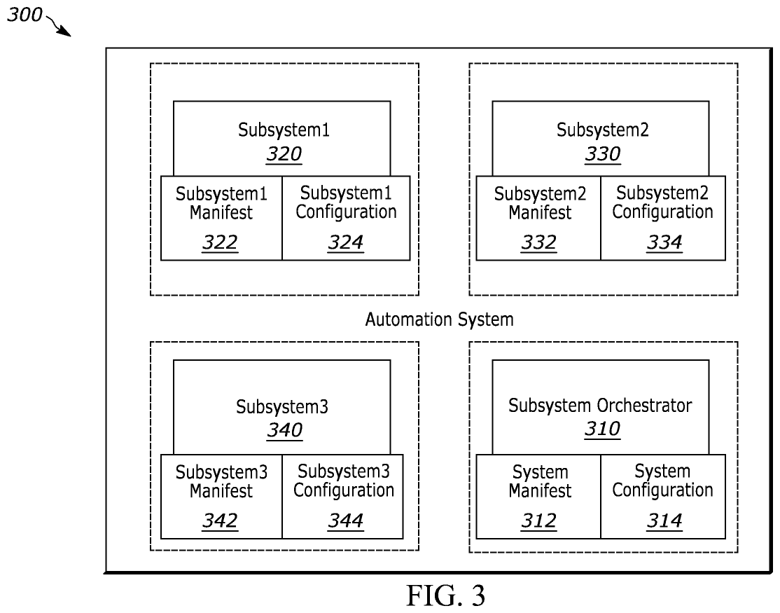

FIG. 3 illustrates such an example of a “system of systems”, showing an automation system 300 comprised of multiple subsystems 320, 330, and 340. In the example of FIG. 3, automation system 300 includes system orchestrator 310 and associated system manifest 312 and system configuration definition 314. Automation system 300 also includes, in this example, three subsystems 320, 330, and 340. Each subsystem has an associated manifest and configuration definition—subsystem1 320 is associated with manifest1 322 and configuration definition1 324, subsystem2 330 is associated with manifest2 332 and configuration definition2 334, and subsystem3 340 is associated with manifest3 342 and configuration definition3 344. Note that, in other implementations, there can be any number of subsystems.

The manifest and configuration definition for each subsystem is the system manifest and system configuration for that subsystem, and each subsystem may itself comprise one or more apps, each having an associated manifest and configuration definition. In this way, each subsystem can have multiple functions, inputs, and outputs, as may be implemented by its apps, collectively managed and presented to the parent system by that subsystem's system orchestrator and associated system manifest and system configuration definition.

In this way, each subsystem 320 includes additional associated files—the manifest 322 and configuration definition 324—that together define the functions and interfaces of the subsystem 320 so that the subsystem 320 can be treated as a modular component of the overall automation system 300. The system orchestrator 310 can use, instantiate, and configure the subsystem 320/330/340 on the fly during system startup or execution.

According to various embodiments, a manifest (such as a manifest 222 or a system manifest 212) is maintained as a static file that describes the general details of the corresponding system or app and is immutable. For example, a system manifest can contain general metadata, the used services or apps within the system and an interface definition that consists of the named ports, the direction of the interface, and a definition for its type. Similarly, an app manifest can contain general metadata, the function or processes performed by the app, an interface definition that defines the required inputs and the outputs of the functions, the named ports, the direction of the interface, and a definition for its type. The system manifest can include or comprise information from each of its app manifests, and can be created, in whole or in part, by reading and combining the manifests of its subordinate subsystems and apps.

According to various embodiments, a configuration file, whether a configuration definition or a system configuration definition, describes a particular system instance and is mutable (and may be referred to herein as simply a “configuration”). It can contain, for example, instance-specific metadata and instructions for middleware that is used within the system. To instantiate two separate system instances from the same manifest, two separate Configuration files are needed.

With the help of manifest and configuration files as described herein, a developer or other user is able to describe the contents of a system as well as specific runtime features such as parameters for the validation or the startup order of services, functions, apps, or subsystems within that system.

The system orchestrator is defined for every system, whether it is a system orchestrator 210 for an automation system 200 comprised of apps or a system orchestrator 310 for an automation system 300 comprised of subsystems. The system orchestrator manages communication and coordination between and among the modular components of the automation system. The system orchestrator reads both files of the system manifest and the system configuration. The system orchestrator operates as another service within the automation system and operates within automation system boundaries. Note that the examples of FIGS. 2 and 3 do not illustrate a hierarchy between the various apps or subsystems. A system orchestrator as disclosed herein can bind all the apps and the configurations together and can derive individual app configurations from the system configuration. The system orchestrator can control other functions as described herein, including creating gateways for communications with other systems and processes, creating connectors between the apps and subsystems, and others. In some cases, the system orchestrator may create “dummy” connectors that take the place of a connector that may be required by an app or subsystem but is not yet available because of the startup or execution status of the another app or subsystem.

A modular automation system as disclosed herein can therefore comprise a system manifest, a system configuration, a system orchestrator, and one or more user-specified apps or subsystems that can perform the automation task at hand. Systems are completely self-sustained.

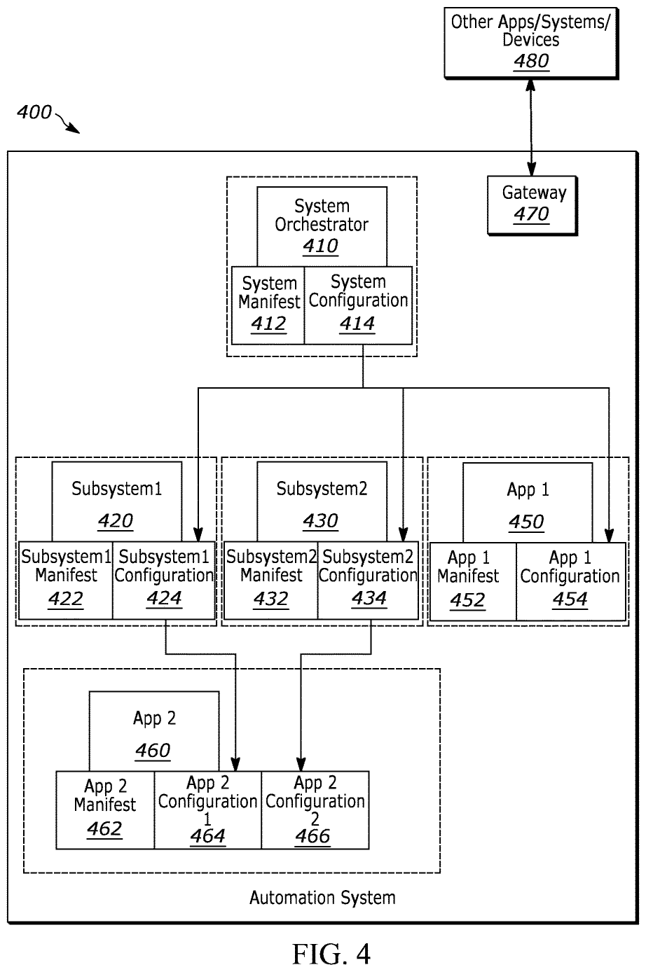

In various embodiments, an automation system can include any combination of subsystems and apps. FIG. 4 illustrates an example of a hierarchal automation system 400 in accordance with disclosed embodiments. Automation system 400 includes a system orchestrator 410, with system manifest 412 and system configuration 414, at the top level.

At the next level are subsystem1 420 (with subsystem1 manifest 422 and sysbystem1 configuration 424), subsystem2 430 (with subsystem2 manifest 432 and sysbystem2 configuration 434), and app1 450 ((with app1 manifest 452 and app1 configuration 454).

At the third level is app2 460, with app2 manifest 462 and two configurations: app2 config1 464 and app2 config 2 466. This illustrates that app2 460 exists or functions in two instances—a first instance defined by app2 manifest 462 and app2 config1 464, and a second instance defined by app2 manifest 462 and app2 config2 466.

The hierarchy can be identified or defined by the references between configuration files. In this non-limiting example, the system configuration 414 references subsystem1 configuration 424, subsystem 2 configuration 434, and app1 configuration 454. Subsystem1 configuration 424 references app2 config1 464 (as app2's first instance) and subsystem2 configuration 434 references app2 config2 465 (as app2's second instance).

The relevant content for each system and each app within an automation system can be stored in the configuration file for the uppermost system, such as in the system configuration 414. During the deployment process, the relevant parts of the configurations from the aggregated configuration files can be passed down to the subordinate systems and apps. That is, the system configuration 414 can reference subsystem1 configuration 424, subsystem 2 configuration 434, and app1 configuration 454. When the system orchestrator 410 invokes or instantiates each of these systems or apps, the system orchestrator 410 can define instance-specific metadata, configuration data, instructions, or other data and insert it in the configuration file for the respective subordinate systems or apps.

To allow a system to be able to communicate beyond its system boundaries with other apps and systems as a modular unit, the system orchestrator of a given system can set up, in the system configuration 414, any required configuration data to maintain a system “gateway” 470 or communication with other apps, systems, and devices 480 based on defined interface names, types, and connections of that system. As non-limiting examples, higher-level control systems can communicate with and use automation system 400 via gateway 470, or automation system 400 can control physical devices such as sensors, actuators, and others via gateway 470. Gateway 470 can include any connectors or data “translators” to achieve correct communications between the automation system and other or external devices or systems. Gateway 470 can be implemented as an app with its own manifest and configuration, for interfacing with internal or external systems that do not support the system native format or that cannot be reached directly from within the current system, for example in cases where separation, partitioning, or other security techniques are used to isolate systems and apps.

Gateway 470 can be implemented as an app as disclosed herein, with its own configuration and manifest. In various embodiments, gateway 470 is used for interfacing with systems that do not support the system native format of communication over the automation system data distribution system (like DDS). In many cases, all apps and sub-systems in the automation system exchange data through the same data distribution system, so the gateway 470 can perform any necessary data translations or conversion to enable all systems to communicate as necessary over DSS. Various embodiments can be implemented using the RTI CONNEXT DDS software by Real-Time Innovations.

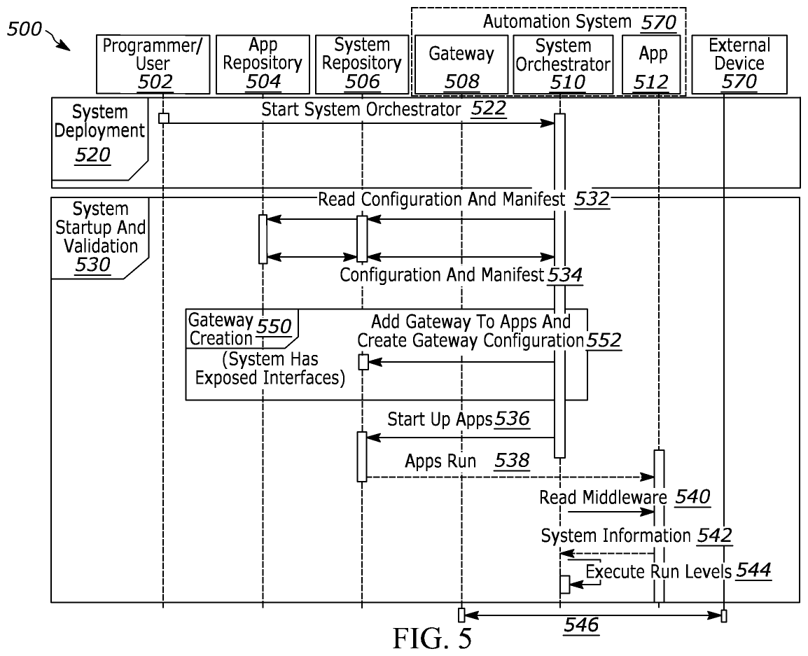

FIG. 5 illustrates an example of processes in accordance with disclosed embodiments, for starting an automation system 570 and generating an automation system gateway 508, both implemented in one or more data processing systems (referred to in the singular below). Each process described below as performed by a software component, operating one or more data processes, can be considered to be performed by the data processing system.

As illustrated in this example, a process can begin with a programmer or other user 502 starting or invoking the system orchestrator 510 for an automation system 570 in a system deployment phase 520, and the system orchestrator 510 begins execution on the data processing system (522). In other cases, the system orchestrator 510 could be started by another device or process.

The data processing system enters the system startup and validation phase 530. The system orchestrator 510 reads the system configuration and manifest (532) such as from a system repository 506 on a data processing system file system. This can also include reading any app configurations and manifests, as may be indicated or linked, directly or indirectly, by the system configuration or manifest, such as from an app repository 504 on a data processing system file system.

The system orchestrator 510 receives the system configuration and manifest (534). This can also include receiving any app configurations and manifests as described above.

The system orchestrator 510 can create a gateway 508 that exposes the defined interfaces of the automation system 570 to other systems, devices, and processes, such as for controlling physical devices or interacting with other systems and processes (550).

As part of gateway creation 550, the system orchestrator 510 can add the gateway to any automation system apps 512 (if so defined by the app configuration or system configuration) and creates a gateway configuration (552). The gateway configuration can be stored in system repository 506.

The system orchestrator 510 starts up one or more apps 512 from the system repository 506 (536) according to the app configuration or system configuration. The app 512 will be referred to in the singular here, but can refer to any number of independently operating apps or subsystems. Note, in particular, that when there are multiple apps 512 (or subsystems), the system orchestrator 510 can perform the startup process in the order or timing required to ensure that dependencies between apps 512 (or subsystems) are satisfied.

The automation system 570 instantiates the app 512 from the system repository 506, which begins running in the automation system 570 (538). Based on the configuration and manifest, the system orchestrator can ensure that each app 512 is executing on the appropriate hardware according to its requirements.

The app 512 can read any secondary/middleware requirements from the system orchestrator 510 (540). In some embodiments, apps can have their initial or default configuration in the format of a file-based app configuration which is derived from the system configuration. Based on the initial configuration, the application can start to operate and connect to the middleware, such as data distribution system as described herein. This initial configuration may include data such as connection string and/or connection parameters.

After successful connection to the middleware, the app can read a secondary configuration (540), which can amend/override the initial configuration. In various embodiments, this is read from the external middleware rather than from the system orchestrator 510. (542).

Once the app 512 has successfully configured itself from the multiple configuration sources, it can publish back, to the middleware, the complete configuration, and can return system information to the system orchestrator 510 (542).

The app 512 continues to execute as configured, under control of the system orchestrator 510 (544). In particular, system orchestrator 510 can control the operation of each of the apps 512 (or subsystems) to ensure that data and timing dependencies between them are satisfied. For example, the system orchestrator 510 can ensure that the app 512 has reached its desired run level. Once an app 512 reaches the desired run level, the system orchestrator 510 can start other apps 512 which require a given run level to ensure that dependency between apps is satisfied. Timing requirements are satisfied by the middleware such as the data distribution system.

Thereafter, the various apps 512 can communicate between themselves, and can communicate with external devices 570, either directly or through gateway 508 (546).

While various embodiments can include manifests and configurations that are maintained in any machine-readable format, implementations that create and use manifests and configurations that are both human-readable and machine-readable are particularly advantageous. Automation objects such as apps, subsystems, etc. in software-defined automation and industrial systems have states and behaviors and can have multiple connections to other automation objects and to external devices and processes. The states and behaviors of the automation objects and of the connections determine the way the system works. As disclosed herein, the configurations are used to specify the initial state and the parameters for the behaviors in an automation object and to set-up the connections among the automation objects and between automation objects and the physical world. These configurations are used to instantiate, start, and control the automation objects and the gateways by the system orchestrator.

Various embodiment can implement manifests and configurations using existing, open, human readable and understandable textual standards, such as YAML, JSON, or XML, to declare, initialize and configure the automation objects in a declarative way.

Each automation object has a manifest artifact (for example a file), which is the declaration for the given automation object type.

The automation object manifest, whether an app manifest or a system/subsystem manifest, declares the automation object's meta information, the possible state variables including those that can be used for initialization, the data points the automation object can connect to as reader, a writer, or as a reader and writer, the automation object's behaviors that can be consumed by external partners, like other connected automation objects, and the stateful and stateless signals the automation object produces.

The following is a non-limiting example of a manifest in YAML format, in accordance with disclosed embodiments:

| | |
|---|---|
| appType: | |
| name: ‘app’ | |
| creator: ‘Siemens Corp.’ | |
| description: ‘sample’ | Meta information for |
| license: ‘General GNU GPL’ | the app |
| copyright: ‘Siemens Corp. (C) 2022’ | |
| orderInformation: ‘6ES9XXX-6BE01- | |
| 2XXX’ | |
| version: ‘0.5’ | |
| signature: ‘ . . . ’ | |
| appParameters: | |
| - name: ‘simulationMode’ | |
| type: ‘boolean’ | |
| defaultValue: ‘true’ | State variables |
| - name: ‘setPoint’ | |
| type: ‘int32’ | |
| defaultValue: 20 | |
| tags: | |
| - name: ‘switch’ | |
| dataType: ‘boolean’ | |
| initialValues: false | Data point the app |
| direction: ‘publisher’ | produces |
| qos: ‘redundant’ | |
| - name: ‘temperature_data’ | |
| structureType: ‘structuredType’ | |
| tagElements: | |
| - name: ‘temperature’ | |
| initialValue: 20 | Data point the app |
| - name: ‘isValid’ | consumes |
| initialValue: true | |
| direction: ‘subscriber’ | |
| alarms: | |
| - name: ‘timeout’ | Stateful and |
| events: | stateless signals |
| - name: ‘incoming_event’ | |
| callables: | |
| - name: ‘temperature_controller’ | |
| parameters: | |
| - name: ‘temp_in’ | |
| type: ‘int’ | |
| direction: ‘in’ | |
| displayName: ‘Temp_C’ | |
| initialValue: 20 | |
| unit: ‘Celsius’ | |
| - name: ‘set_value’ | |
| type: ‘int’ | Consumable behaviors |
| direction: ‘in’ | |
| displayName: ‘Set_Value’ | |
| unit: ‘Celsius’ | |
| - name: ‘switch_on’ | |
| type: ‘boolean’ | |
| direction: ‘out’ | |
| displayName: ‘Switch_On’ | |
| initialValue: false | |
| applets: | |
| - name: ‘applet_example’ | |
| appParameters: | |
| - name: ‘applet_param’ | |
| type: ‘int32’ | |

As described above, the disclosed automation objects can have instances, and each instance is described or defined by the corresponding configuration definition, whether an app configuration or a system configuration. The configuration, based on the manifest, specifies the required settings for the specific instance. The configuration can provide meta information about the automation object instance, provide the values to the state variables, to the parameters of behaviors, can declare the details for signals and can provide the connection information to the data points, to other automation objects, and/or to physical devices, for example. The system manifest can be used to configure common parameters for some or all of its subordinate subsystems and apps, using specific declarations or reusable variable settings. The system configuration can also include such information as dependencies between the apps and subsystems, required ready states of the apps and subsystems, and the order and/or timing in which the apps and subsystems must be started.

The following is a non-limiting example of a configuration in YAML format, in accordance with disclosed embodiments:

| | |
|---|---|
| appInstance: | |
| name: ‘app (instance)’ | |
| appType: ‘myApp’ | |
| domain: 0 | |
| system: ‘system-1’ | |
| description: ‘sample’ | Meta information |
| startToRunLevel: 10 | for the app |
| appRunLevel: | instance |
| - name: “shutdown” | |
| systemRunLevel: −1 | |
| description: “ ” | |
| - name: “idle” | |
| systemRunLevel: 0 | |
| description: “ ” | |
| - name: “app_ready” | |
| systemRunLevel: 10 | |
| description: “ ” | |
| appConfig: | |
| - name: ‘simulationMode’ | State variable |
| value: false | initialization |
| tags: | |
| - name: ‘switch’ | Connect produced |
| connect: ‘air_heater_on’ | data |
| - name: ‘temperature_data’ | |
| connect: ‘temperature_in’ | Connect consumed |
| | data |
| alarms: | |
| - name: ‘timeout’ | |
| responseType: ‘acknowledgement’ | |
| eventText: ‘The operation timed out’ | Define the |
| | stateful and |
| events: | stateless signals |
| - name: ‘force_heater_on_click’ | |
| direction: ‘in’ | |
| calls: | |
| - name: ‘tempHandler’ | |
| callable: ‘temperature_handler’ | |
| implementation: | |
| kind: ‘script’ | |
| engine: ‘python3’ | |
| path: ‘./tempHandler.py’ | |
| invocation: | |
| parameters: | |
| - name: ‘temp_in’ | |
| value: | |
| ‘tags[structuredTag_example].temperature’ | Parametrize and |
| - name: ‘set_value’ | connect the |
| value: ‘appConfig[setPoint]’ | consumable |
| - name: ‘switch_on’ | behaviors |
| value: ‘[[ $? > 1 ]]’ | |
| trigger: | |
| - kind: ‘cyclic’ | |
| value: ‘WallClock.Minute’ | |
| applets: | |
| - name: ‘applet_example_instance’ | |
| type: ‘applet_example’ | |
| appConfig: | |
| - name: ‘applet_param’ | |
| value: 11 | |

The use of separate manifest and configuration ensures that the automation object creator (for example, an automation app developer) needs only to specify what inputs are needed for and supported by the automation object, and the automation object user (for example, an automation system designer) needs only to specify these parameters. The strict separation of creation and consumption is thereby ensured, making sure that a recompilation of the automation object is not needed during the integration into an automation system.

This structure also allows the ability to create indefinite, user-defined chaining of configurations and enables the building of system(s) of apps as described above. Parts of the configuration can be inherited by one app or system from another. During the deployment process, the relevant parts of the configurations from the aggregated configuration files can be passed down to the subordinate systems and apps. That is, the relevant content for each system and each app within an automation system can be stored in the configuration file for a higher-level or the uppermost system, such as in the system configuration 414. In the example of FIG. 4, the system configuration 414 can reference subsystem1 configuration 424, subsystem 2 configuration 434, and app1 configuration 454. When the system orchestrator 410 invokes or instantiates each of these systems or apps, the system orchestrator 410 can define instance-specific metadata, configuration data, instructions, or other data and insert it in the configuration respective subordinate systems or apps. In various embodiments, the system manifest 412 can reference or incorporate the other manifests of the automation system, such as subsystem1 manifest 422, subsystem2 manifest 432, app1 manifest 452, and app2 manifest 462.

In various embodiments, the disclosed configurations can be created, stored, transmitted, or received in a number of different ways, for example, as a file, as a message in a messaging system, as a parameter in a REST call, etc.

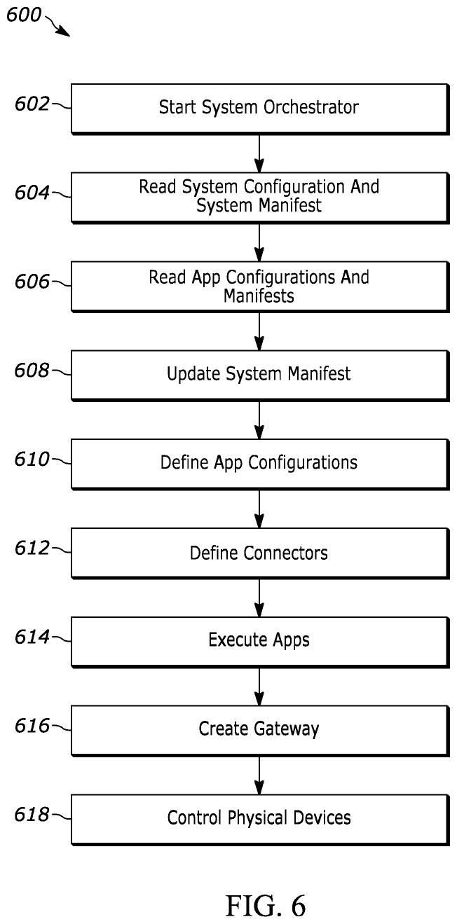

FIG. 6 illustrates an example of a process 600 in accordance with disclosed embodiments, for implementing an automation system 152 and generating an automation system gateway 164, both implemented in one or more data processing systems 100 (referred to in the singular below). Each process step described below as performed by a software component, operating one or more data processes, can be considered to be performed by the data processing system. In accordance with the embodiments disclosed herein, any app, and its configuration and manifests, may be implemented by a subsystem that is treated by the system orchestrator as an app.

The process begins with starting a system orchestrator 168 (602). The system orchestrator can be started by a user, by another automation system as part of a subsystem, or by another device or process.

The system orchestrator 168 can read a system configuration definition 156 and system manifest 158 (604);

The system orchestrator 168 can read app configuration definitions 156 and/or app manifests 158 for one or more apps 154, based on the system configuration definitions 156 (606). The app configuration definitions 156 can be default configurations.

The system orchestrator 168 can update the system manifest 156 according to the app manifests 156 for the one or more apps 154 (608).

The system orchestrator 168 can define app configuration definitions 156 for one or more apps 164 based on the system configuration definition 156 (610). This can include updating the default configuration definitions according to the specific requirements of the apps. This can include defining multiple instances for a same app 164 using different app configuration definitions 156, thereby creating multiple app instances each using a different app configuration definition.

The system orchestrator 168 can define connectors 170 for the one or more apps 164 (612). This can include defining a dummy connector 170 for at least one of the one or more apps 164.

The system orchestrator 168 can execute the one or more apps 164 based on the app configuration definitions 156 and the app manifests 158 (614). This can include controlling the timing of the execution of individual ones of the one or more apps 164.

The system orchestrator 168 can create a gateway 164 (616).

The system orchestrator 168 or automation system 152 can control at least one external physical device 570 based on the one or more executing apps 164 (618). The external physical device can be controlled via the gateway.

The system and methods disclosed herein provide numerous technical advantages over the prior art. For example, an automation system using modular automation apps enables flexible and efficient creation and deployment of complex solution structures, and this technical advantage provides commercial advantages in the ability to create automation systems in a more flexible and efficient way and therefore respond to changing market demands, time-to-market pressure, continuously emerging new technologies and, above all, global competition.

The system orchestrator disclosed herein allows for an overarching and system-wide control and coordination of the automation system that reaches beyond the functionality of any single app in the automation system. Aspects such as starting up each app on the correct hardware with the right configuration in a user-defined or system-defined order can only be accomplished using a system orchestrator as disclosed, apart from the actual automation apps. The system orchestrator operates to ensure that the automation system as a whole is less error prone and therefore more cost efficient. The system orchestrator oversees every app and subsystem at runtime to ensure that they are in a working functional state, the system orchestrator validates the operation and interactions of each of the apps (and the gateway, as necessary) to ensure that the apps and the automation system as a whole are interconnected in the right way to fully support the automation system functions. In this way, the system orchestrator ensures that within the automation system, the apps can correctly and efficiently communicate with each other, and that the automation system as a whole can communicate correctly and efficiently with externals systems, devices, and processes.

The app repository and system repository, which can include manifests and system/app configurations stored as discrete files, enables the individual applications and systems to be version controlled, shared, and deployed across multiple versions and variants.

By enforcing type and instance configurations for configuring automation objects, disclosed embodiments ensure the easy creation, distribution, and reuse of automation software. Separating the configuration of the automation objects into separate artifacts—configuration and manifest—enables design of industrial and other automation systems in a flexible, modular, and distributed architecture. This approach also enables the chaining and embedding of the automation objects. Using configurations for specifying the functional details of the automation objects avoids the necessity to recompile them during integration to an industrial automation system.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to be treated as “means plus function” type limitations unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves.

1. A method for implementing an automation system, the method performed by a data processing system and comprising:
starting a system orchestrator;
reading a system configuration definition and system manifest by the system orchestrator;
reading app configuration definitions and app manifests for one or more apps, by the system orchestrator, based on the system configuration definition;
defining app configuration definitions for one or more apps, by the system orchestrator, based on the system configuration definition;
executing the one or more apps based on the app configuration definitions and the app manifests; and
controlling at least one external physical device, by the automation system, based on the one or more executing apps.

2. The method of claim 1, further comprising creating a gateway by the system orchestrator.

3. The method of claim 2, wherein the at least one external physical device is controlled via the gateway.

4. The method of claim 1, further comprising updating the system manifest according to the app manifests for the one or more apps.

5. The method of claim 1, wherein the system orchestrator controls the timing of the execution of individual ones of the one or more apps.

6. The method of claim 1, wherein the system orchestrator defines connectors for the one or more apps.

7. The method of claim 1, wherein the system orchestrator defines a dummy connector for at least one of the one or more apps.

8. The method of claim 1, wherein the defining app configuration definitions for one or more apps includes defining multiple instances for a same app using different app configuration definitions.

9. A data processing system comprising:
a processor; and
an accessible memory, the data processing system particularly configured to perform a method according to claim 1.

10. A non-transitory computer-readable medium encoded with executable instructions that, when executed, cause one or more data processing systems to perform a method according to claim 1:
